(19) United States
(12) Patent Application Publication
(10) Pub. No.: US 2013/0088356 A1
(43) Pub. Date: Apr. 11, 2013

(54) TAKAN ALARM INCLUDING ANY PLURALITY OF SERIES CONNECTED MODULES FOR USE WITH AN INTERCONNECTED ARCHITECTURE NETWORK OF FLUID CONDUIT LINES

(71) Applicant: Ken Hardin, Flint, MI (US)

(72) Inventor: Ken Hardin, Flint, MI (US)

(21) Appl. No.: 13/646,775

(22) Filed: Oct. 8, 2012

Related U.S. Application Data
(60) Provisional application No. 61/544,467, filed on Oct. 7, 2011.

(51) Int. Cl. G08B 21/00

(52) U.S. Cl. 340/626; 340/540

(57) ABSTRACT

A processor incorporated into an alarm system which includes a PC board supporting a first component for output characteristics including a strobe light and/or audible siren. A second component is integrated into the PC board for providing power and for communicating with first and second locations associated with a conduit line to be monitored, with a third component providing the visual or audio output. The second component connects to an identically constructed PC board located in a remote succeeding alarm. The alarm is capable of monitoring at least one of an electrical conductivity or a fluid pressure condition contained within the conduit lines.

### CROSS REFERENCE TO RELATED APPLICATIONS

The present application claims the priority of U.S. Ser. No. 61/544,467 filed Oct. 7, 2011.

### FIELD OF THE INVENTION

The present invention discloses an alarm processor and related components which employs a plural and series connected network incorporated into a dedicated and interconnected conduit architecture for issuing a chorus style alarm in the event of an alarm condition indicated at any location, and which is typically evident from sectioning of a conduit line (resulting in either or both of loss of measured fluid pressure and interrupting electrical conductivity across the conduit indicative of the line being sectioned). As will be further described, the connecting wires are typically mounted to internal and external pipe locations of an associated building and the associated schematics further designate a novel architecture in which a 14 pin multichip is built into the PC board and interfaces with a first multi pin connector for programming audio and light output, a second eight multi wire port connector for including each of LINK next alarm, strobe light, two wires to conduit and Ground, and a third two pin output to speaker.

### DESCRIPTION OF THE BACKGROUND ART

The prior art is documented with examples of theft deterrent alarm systems, such as which are employed in the protection of equipment including conduit communicating copper lines associated with air conditioning and other equipment. Notable among these are the security system for monitoring a product as set forth in U.S. Pat. No. 6,690,277 and which includes a splitter box to which is coupled a main controller unit for transmitting data to be stored in a table. The data is then transmitted to a second shift register disposed in the splitter box, at which a logic circuit compares the data to a signal indicating whether the product is still coupled to the sensor, at which an alarm signal is generated if the product is no longer coupled to the sensor. The alarm signal is subsequently transmitted to the main controller unit which responds by sounding a horn.

Stapleton, U.S. Pat. No. 6,523,070, teaches a communication apparatus having a plurality of communication devices each including ports and a data bus interconnecting a plurality of units. Each device is provided with means enabling the device to detect automatically its position on the data bus.

Schempf, U.S. Pat. No. 6,778,100, teaches a conduit network system exhibiting a plurality of node elements in communication with an inner area of a conduit. The node elements can receive, process and communicate data signals that are representative of user-desired information. A system control mechanism is in communication with the node elements and receives the data signals from the node elements.

Egan, U.S. Pat. No. 7,817,036, teaches a system and method for determining a physical location of one or more units in a rack including using physical cables extending between rack units, cascading a first signal through the units which is encoded with a unit number and a physical parameter, and creating a rack ID by utilizing hardware parameters which are determined by detecting a second signal that exists from a bottom unit of the rack. A third signal, either cabled or optical, is used to send data between the units in the rack by manipulating void spaces within the rack.

### SUMMARY OF THE PRESENT INVENTION

The present invention discloses a processor incorporated into an alarm system which includes a PC board supporting a first component for programming at least one output characteristic including at least one of light and sound. A second component is integrated into the PC board for providing power and for communicating with first and second locations associated with a conduit line to be monitored and a third component is provides an audio output. The second component connects to an identically constructed PC board located in a remote succeeding alarm.

Additional features include the alarm output associated with the second component further having a strobe light. In operation, the alarm capable of monitoring at least one of an electrical conductivity or a fluid pressure condition contained within the conduit lines.

Other features include a housing containing the processor and siren output and in localized communication with the strobe light. Also, the alarm system can be configured to communicate with a remote monitoring location via at least one of a wired or wireless network communication protocol.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an environmental schematic view of the alarm unit in communication with locations of fluid carrying copper lines extending between an environmentally located condensing unit and a blower component, such as incorporated into an interior located furnace;

FIG. 2 is a sectional schematic of a pair of PC board components associated with the alarm unit arranged in series and illustrating various connections to power supply, strobe light, copper pipe connections, etc.;

FIG. 3 is a wiring diagram of a selected PC board depicted in FIG. 2;

FIG. 4 is a parts listing of components reflected in the wiring diagram of FIG. 3;

FIG. 5 is a first side perspective of a PC board;

FIG. 6 is a plan depiction of the PC board layout in FIG. 5;

FIG. 7 is a second reverse side perspective of the PC board depicted in FIG. 5;

FIG. 8 is an illustration of the PC board and components mounted within a housing including an alarm siren output; and

FIG. 9 is a further illustration depicting the alarm housing mounted to a location proximate a strobe light.

### DETAILED DESCRIPTION OF THE PREFERRED EMBODIMENTS

Referring now to the following detailed description, the present invention discloses an alarm processor and related components which employs a plural and series connected network incorporated into a dedicated and interconnected conduit architecture for issuing a chorus style alarm in the event of an alarm condition indicated at any location. Triggering of the alarm is usually evident from sectioning of a conduit line (resulting in either or both of loss of measured fluid pressure and interrupting electrical conductivity across the conduit indicative of the line being sectioned).

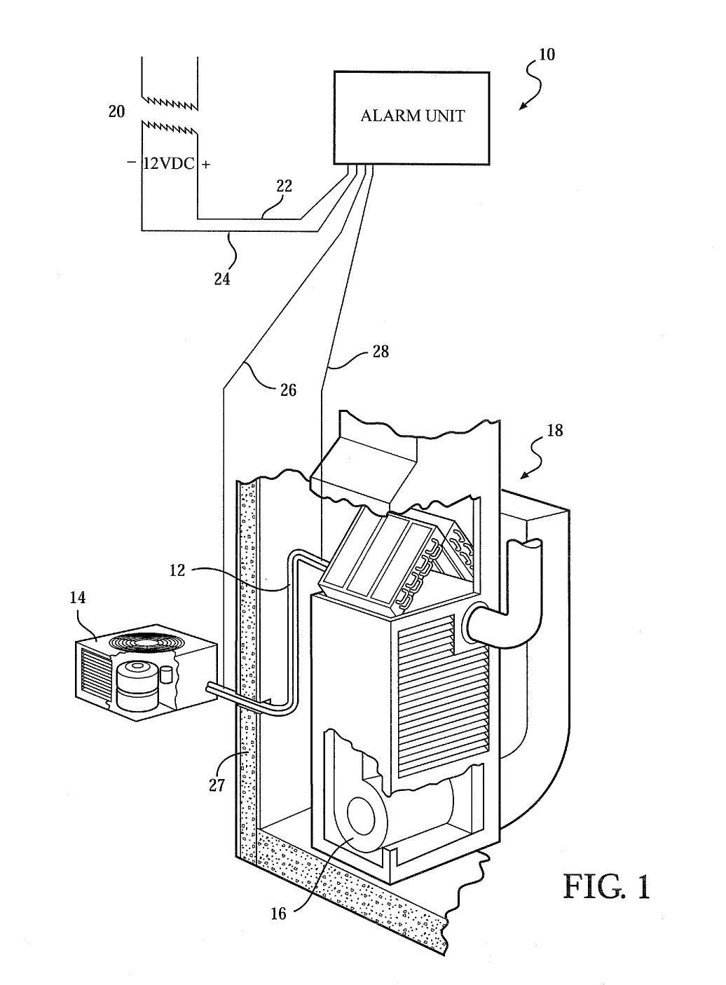

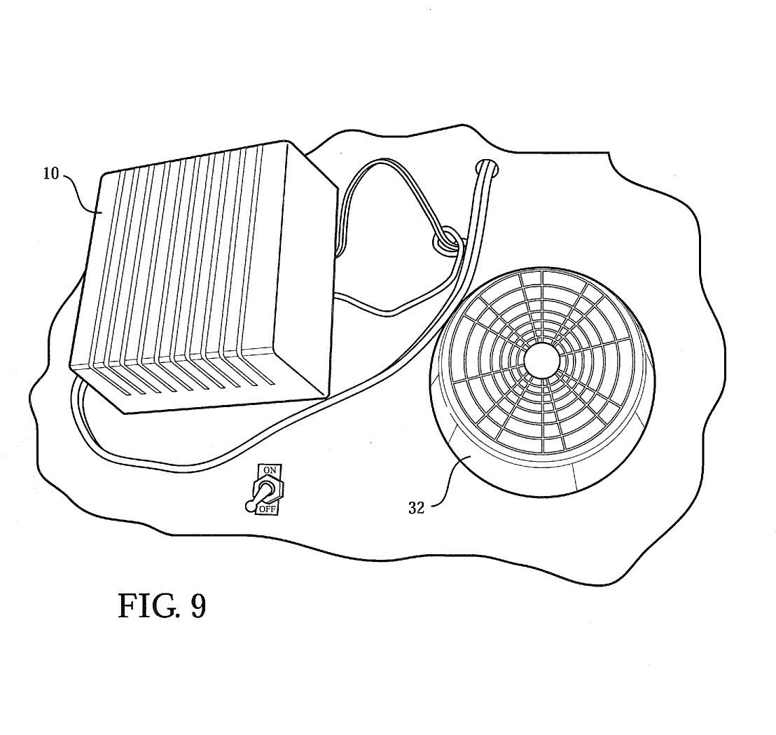

The component supporting PC board defining the alarm processor can be utilized with any theft detection system, such as which is indicative of section of a copper pipe. With reference initially to FIG. 1 in combination with FIGS. 8 and 9, an environmental schematic view of the alarm unit is generally designated at 10, in communication with locations of fluid carrying (e.g. such as including but not limited to copper) lines 12 extending between an environmentally (typically exterior) located condensing unit 14 and a blower component 16, such as incorporated into an interior located furnace 18.

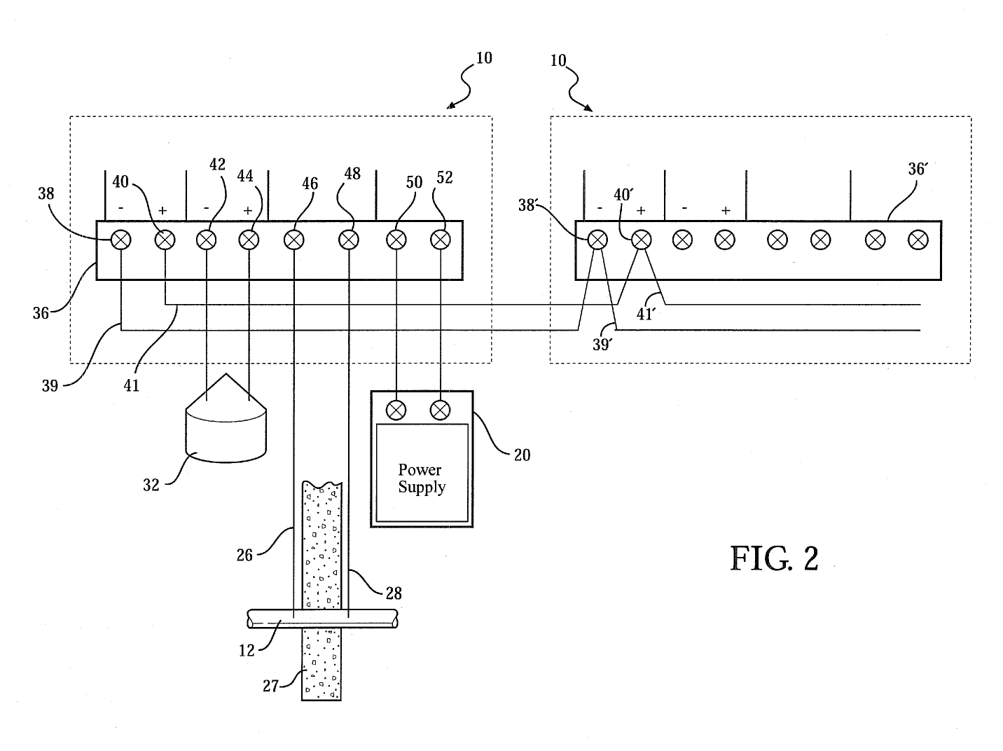

As further depicted in FIG. 1, a 110 VAC to 12 DC power supply 20 (such as also depicted in schematic in FIG. 2) provides power to the alarm unit, via first (typically red) 22 and second (black) 24 lines. Additional first and second output lines 26 and 28 are also depicted and which are wired in series to conduit (e.g. typically copper) line locations associated with the condensing unit 14 and furnace 18 (such as at either or both of exterior and interior locations of a facilitate as depicted by a wall shown at 27 and which operate under the principle of signifying an alarm condition upon closing of an associated electrical circuit (resulting from loss of electrical contact indicate of the copper pipe being sectioned or a low pressure fluid switch being energized as a result of reduced or lost fluid pressure likewise indicative of pipe sectioning).

Additional features include a siren output 30 (see FIGS. 8 and 9) and optional flashing strobe 32 (FIGS. 2 and 9) which assist in notifying the existence of an alarm output condition. It is further envisioned and understood that the alarm unit 10 can, additionally or alternatively, be connected in a wired, wireless or other desired fashion to a remote location, such as associated with a security or monitoring company, for notifying any third party of the occurrence of the remote alarm condition.

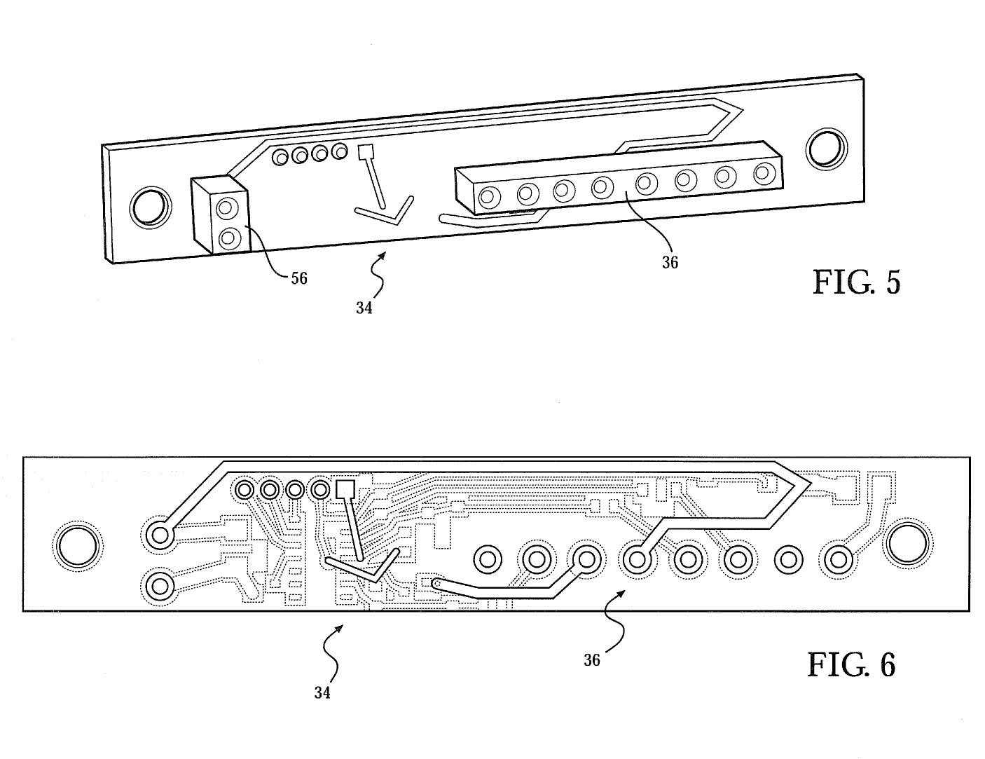

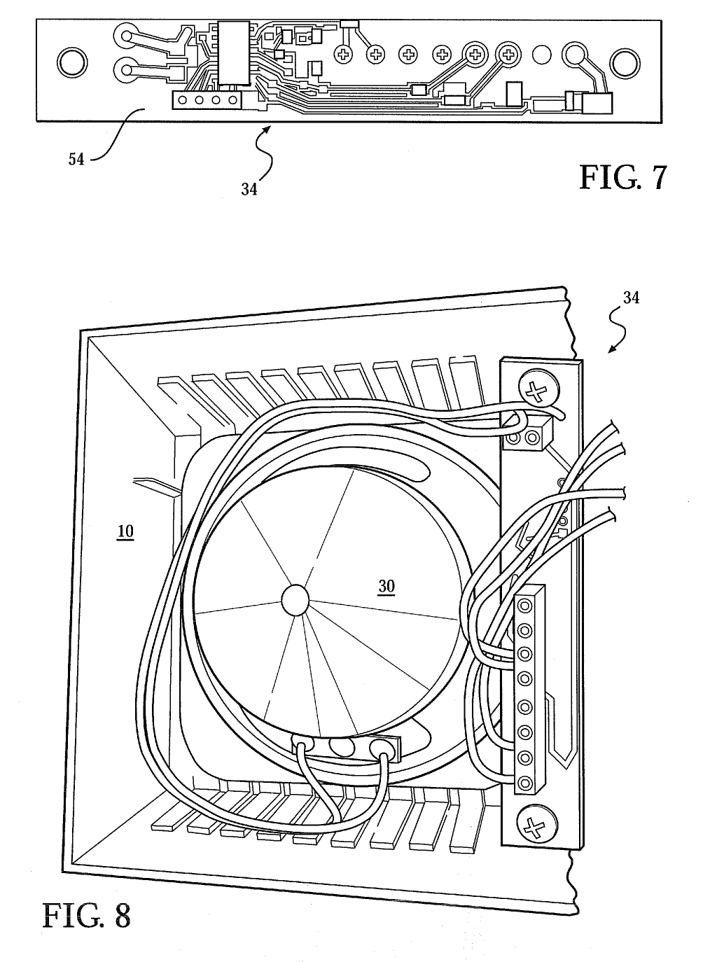

Referring now to FIG. 2 et seq., a component supporting PC scheme is depicted and which includes an overall PCB, as depicted generally at 34 in each of FIGS. 5-7, each of which incorporates a JP2 component 36, with any number of individual such assemblies 10 capable of being connected in series as will be subsequently described. Referring first to the sectional schematic of FIG. 2, the JP2 component is again shown at 36 and is incorporated into each of successive alarm sub-system located PC boards 34 (see also again FIGS. 5 and 6). The JP2 component includes eight output pins including first 38 and second 40 pins corresponding to negative and positive contacts extending via wires 39 and 41 to an optional successive and identically configured component 36′ located in a succeeding series arranged alarm.

It is understood that the alarm system is capable of functioning in a first variant as a single stand-alone alarm and/or, and depending upon either an subsequent up-scaling of such an original single alarm install or an alternate install in which a plurality of identically configured alarm sub-systems are desired, can be constructed in the manner depicted in FIG. 2 by which the alarm sub-systems are connected in a series arrangement and, upon any detecting an alarm condition, resulting in some or all issuing a concurrent alarm output.

Referring again to FIG. 2, additional pin locations for JP2 component 36 include third (negative) 42 and fourth (positive) 44 for communicating connecting black and red wires to the strobe light 32. Pipe connecting contact locations 46 and 48 receive ends of wires 26 and 28 extending to pipe locations 12 also identified in FIG. 1. Ground location pins 50 and 52 are further designated in communication with the power supply, again at 20.

As further noted, each of the previously identified wires 26, 28, 39, 41, etc., can include 24 gauge rating apiece, with the link wires 39 and 41 tested to 75 feet per link (e.g. between individually located units). Each separate alarm utilizes a separate 12V power supply 20 and, as previously noted, can be connected to pressure switches for notifying loss of Freon (coolant fluid) as an additional or alternative to electrically conductive monitoring of the (copper) lines 12.

With reference again to FIG. 2, the pin connection scheme for succeeding JP2 component 36′ is generally identical to that associated with initial described component 36 such that a repetitive description is unnecessary. Each succeeding component 36′ however includes a link wires 39′ and 41′ extending from associated pin locations 38′ and 40′ to a next succeeding JP2 component, with extending ends of the previously described wires 39 and 41 again connecting to the succeeding component pin locations 38′ and 40′.

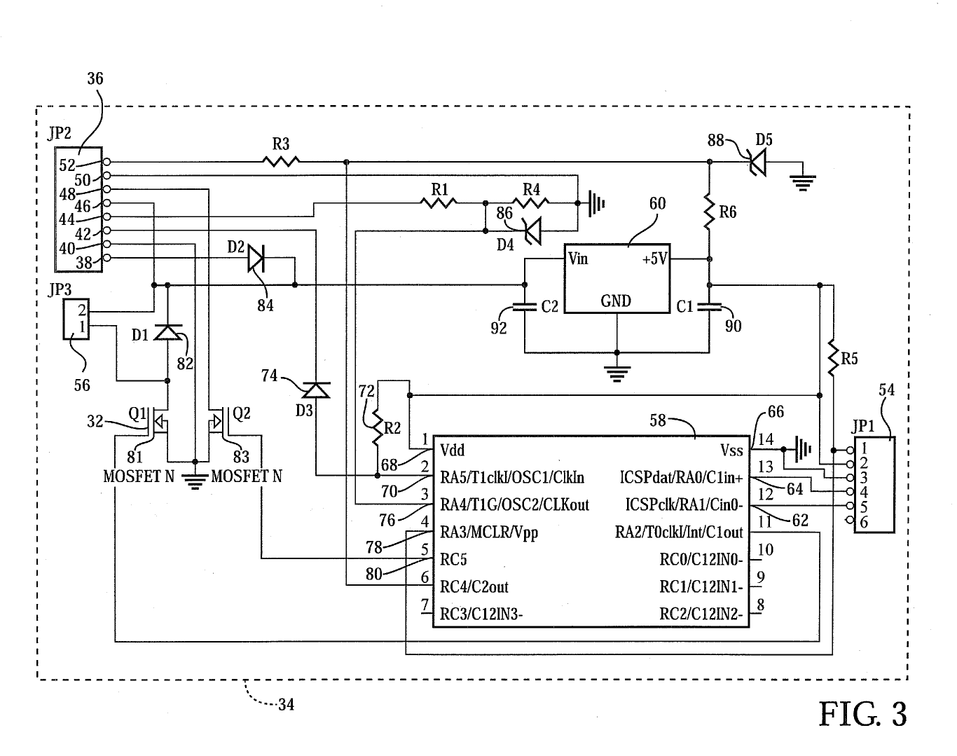

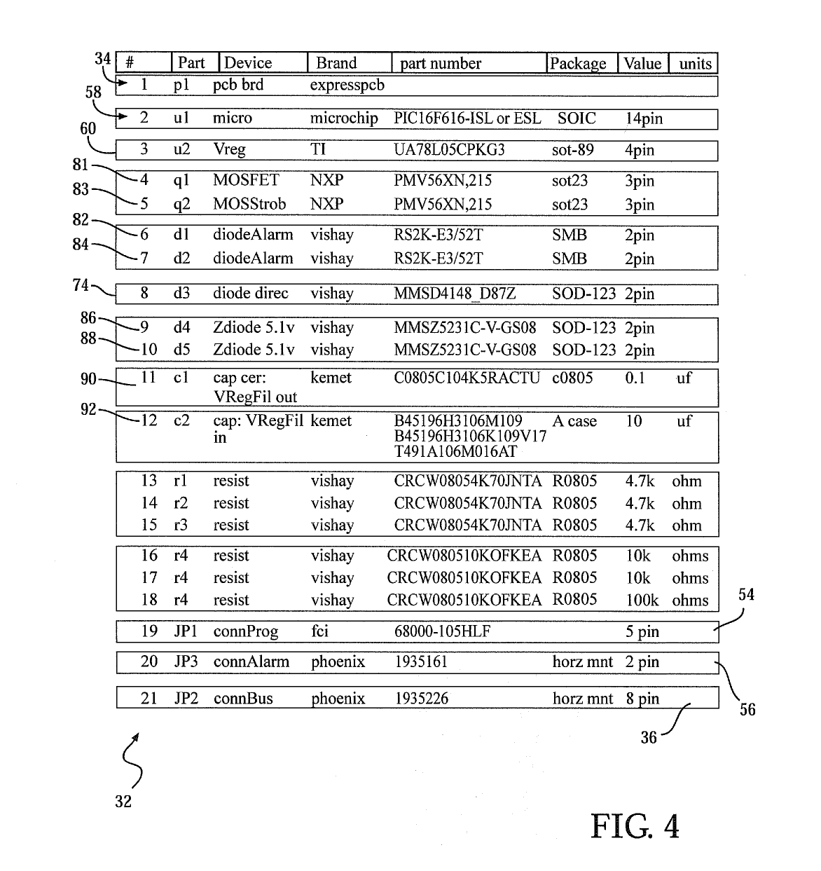

FIGS. 3 and 4 depict a wiring diagram and parts list associated with the PC board 34 supporting the various components including those previously identified as JP2 component 36 in FIG. 2, combined with additional components JP1 (providing the various programming inputs to the alarm system), at 54, and JP3 (providing the speaker outputs), further at 56. A fourteen pin express PCB component is depicted at 58 (see also part #1 in FIG. 4) and, combined with additional other main components including voltage regulating component 60 (see also part #12 in FIG. 4), define components within the overall schematic shown.

As depicted, the schematic further designates a novel architecture in which the fourteen pin chip circuit 58 is built into the PC board and interfaces with a first multi pin connector for programming audio and light output (JP1 54). This is depicted by pins 62 and 64 of the chip 58 which extend to input locations of the six pin alarm programming component 54, with further pin 66 depicting a Voltage source and powering the programmer component 54.

The PC board component 58 likewise communicates with second eight multi wire port connector (see as depicted as JP2 36 and as previously described in FIG. 2 and in which pin locations 38-52 are repeated). As previously described and illustrated, any plurality of components 36 are connected in series fashion.

Additional pin locations associated with the PCB component 58 include at 68 for providing a Vdd output and, in combination with a succeeding pin location 70 connected to a resistor component and communicating diode location 74, powering the components 36 and 54. Also operable from the multichip component 58 is the strobe light 32, as well as the two wires to conduit 26 and 28 and further at 39 and 41 to Ground, as well as a third two pin output (JP3 56) to speaker 30 as depicted in FIG. 8. The programming JP1 component 54 is depicted in communication with the fourteen pin multichip 58 (directly via pins identified at 76, 78 and 80 and indirectly via pins 68 and 70), this in order to program all of the necessary parameters, not limited to the flashing strobe 32, siren output 30, and the like and which are further reflected in the depictions.

Comparing the parts list of FIG. 4 to the schematic depicted in FIG. 3, additional components depicted include the strobe light 32 as depicted by MOSFET switch components Q1 (81) and Q2 (83) (metal-oxide-semiconductor field-effect transistor is used for amplifying or switching electronic signals). Diodes 82 (D1) and 84 (D2) alarms communicate through in outputs to JP3 56 and again to operate the speaker 30 (additionally or alternately to the strobe light 32 again depending upon the protocol entered into the programing component JP1 54.

Additional Zener diodes are depicted at 86 (D4) and 88 (D5), these allowing current to flow in the forward indicated direction in the same manner as an ideal diode (see D1-D3, elements 82, 84, 74), but will also permit flow in the reverse direction when the voltage is above a certain value known as a breakdown voltage, “zener knee voltage” or “zener voltage”. Capacitors 90 (C1) and 92 (C2) arranged in proximity to the voltage regulating component 60 and which are widely used in electronic circuits for blocking direct current while allowing alternating current to pass. Various resistors R1-R4 are also referenced in each of FIGS. 3-4.

The above described selection of components referenced in the schematic of FIG. 3 and itemized in the parts list of FIG. 4 is intended to be non-limiting, with the understanding that other wiring arrangements are contemplated for establishing the required communication protocol for operating the alarm system. Additional and non-limiting applications of the system include connecting to or interfacing with any existing security system and/or to an existing residential, commercial or industrial door bell. The system can also be connected to operate a light for the hearing impaired, connected to any external located bell or buzzer, and/or utilized at more than one location.

Having described my invention, other and additional preferred embodiments will become apparent to those skilled in the art to which it pertains, and without deviating from the scope of the appended claims.

I claim:

1. A processor incorporated into an alarm system, comprising:
a PC board supporting a first component for programming at least one output characteristic;
a second component integrated into said PC board for providing power and for communicating with first and second locations associated with a conduit line to be monitored; and
a third component for providing an audio output.

2. The invention as described in claim 1, said output characteristic further comprising at least one of light and sound.

3. The invention as described in claim 1, further comprising said second component connecting to an identically constructed PC board located in a remote succeeding alarm.

4. The invention as described in claim 1, said alarm output associated with said second component further comprising a strobe light.

5. The invention as described in claim 1, said alarm capable of monitoring at least one of an electrical conductivity or a fluid pressure condition contained within the conduit lines.

6. The invention as described in claim 4, further comprising a housing containing said processor and siren output and in localized communication with said strobe light.

7. The invention as described in claim 1, further comprising said first and second components communicating with a remote monitoring location via at least one of a wired or wireless network communication protocol.

8. A processor incorporated into an alarm system, comprising:
a PC board supporting a first component for programming at least one output characteristic;
a second component integrated into said PC board for providing power and for communicating with first and second locations associated with a conduit line to be monitored, said second component connecting to an identically constructed PC board located in a remote succeeding alarm; and
a third component for providing an audio output.

9. The invention as described in claim 8, said output characteristic further comprising at least one of light and sound.

10. The invention as described in claim 8, said alarm output associated with said second component further comprising a strobe light.

11. The invention as described in claim 8, said alarm capable of monitoring at least one of an electrical conductivity or a fluid pressure condition contained within the conduit lines.

12. The invention as described in claim 10, further comprising a housing containing said processor and siren output and in localized communication with said strobe light.

13. The invention as described in claim 8, further comprising said first and second components communicating with a remote monitoring location via at least one of a wired or wireless network communication protocol.

14. A processor incorporated into an alarm system, comprising:
a PC board supporting a first component for programming at least one output characteristic including at least one of light and sound;
a second component integrated into said PC board for providing power and for communicating with first and second locations associated with a conduit line to be monitored;
said first and second components communicating with a remote monitoring location via at least one of a wired or wireless network communication protocol; and
a third component for providing an audio output.

15. The invention as described in claim 14, further comprising said second component connecting to an identically constructed PC board located in a remote succeeding alarm.

16. The invention as described in claim 14, said alarm output associated with said second component further comprising a strobe light.

17. The invention as described in claim 14, said alarm capable of monitoring at least one of an electrical conductivity or a fluid pressure condition contained within the conduit lines.

18. The invention as described in claim 16, further comprising a housing containing said processor and siren output and in localized communication with said strobe light.
